(19) United States
(12) Patent Application Publication
(10) Pub. No.: US 2011/0271459 A1
(43) Pub. Date: Nov. 10, 2011

(54) PRODUCT

(75) Inventor: Giuseppe Di Bono, Mira (IT)

(73) Assignee: RECKITT BENCKISER N.V., Hoofddorp (NL)

(21) Appl. No.: 13/123,581

(22) PCT Filed: Sep. 29, 2009
(86) PCT No.: PCT/GB2009/002320

§ 371 Date: Jul. 22, 2011

(30) Foreign Application Priority Data
Oct. 13, 2008 (GB) 0818740.3

(51) Int. Cl. C11D 17/04; D06L 1/00

(52) U.S. Cl. 8/137; 510/294

(57) ABSTRACT

A product comprises a pillow made of a plastics sheet material. The material is porous. The product further comprises particles of a support material contained within the pillow. One or more of the particles of support of the plastics sheet material are reversible impregnated with a detergent formulation.

The present invention relates to a product and its use in a cleaning process.

Conventional home-based cleaning garment processes use an immersion process wherein the garments to be cleaned are immersed in an aqueous mixture of detergent and agitated either by hand or in an automatic washing machine. This is fine for the majority of garments, which can tolerate the exposure to the aqueous medium and the (often prolonged) agitation.

However, certain garments, particularly delicate garments cannot be cleaned in this way as the commonly available detergents and their use in an aqueous medium creates too aggressive an environment for their cleaning. As such if conventional washing methods are used then damage to the garments such as physical damage, i.e. shrinking, stretching or tearing or more aesthetic damage, i.e. dye loss/discoloration can occur. This means that many delicate garments can only be cleaned in a dry-cleaning process. Such processes, whilst chemical suitable, suffer from the disadvantages of high cost and low convenience.

Even with conventional garments conventional water based cleaning is becoming increasingly unacceptable due to pressures on the amount and cost of water/detergent used in a cleaning process. Water is an increasingly scarce/costly commodity around the world and flagrant over-use of water is progressively less tolerated.

It is an object of the invention to address/obviate some of the disadvantages mentioned above.

According to a first aspect of the invention there is provided a product comprising a pillow made of a plastics sheet material, the material being porous, the product further comprising particles of a support material contained within the pillow, one or more of the particles of support or the plastics sheet material being reversible impregnated with a detergent formulation.

With the use of a product according to the present invention in a process where the detergent is released, such as a washing process, excellent properties have been observed including ease of use and high efficacy of stain treatment on an item being cleaned in the washing process. It is postulated that this high cleaning efficacy is due to a combination of detergent release from the sheet and/or particles onto an item in combination with absorption of at least some of the soil into/onto the particles. Additionally the particles provide a rubbing effect an item being cleaned in a washing process, aiding soil removal and further improving the efficacy of the process.

Ideally the pillow is based upon a rectangle/square, comprising two sheets of material bonded at or near their perimeters in order to make the pillow shape. The overall pillow surface area (counting both sides of the pillow) is preferably in the range of 900 cm² to 7000 cm². The weight of the sheet material is generally in the range of 50 and 200 g/m².

Ideally the sheet material a single plastic film or a combination of two or more films laminated together. Such films have several advantageous properties in that they have been found to withstand high temperatures (about 140° C.), be inexpensive and display ease of construction.

Preferred film materials include polyethylene, polypropylene, polyester, polyamide, poly ethyl vinyl alcohol. One or more of these materials may further comprise a non-woven material. Preferred examples of non-woven materials include cellulose or viscose, pure or mixed with other materials like polyethylene, polypropylene, etc. or it could be a polypropylene micro-fibre.

Ideally the product comprises an amount of particles of a support material measured in terms relative to the proposed end use of the product. Generally the amount of the particles of the support material is in a weight ratio of between support material:amount of material being addressed of 1:1 and 1:25.

Generally the support material is in the form of small cylinders. The size of the cylinders is preferably such that the cylinders are about 4 mm long and about 2 mm in diameter.

Preferably the support material comprises nylon such as Nylon 6 or Nylon 6,6. Generally the nylon has a molecular weight between 1000 and 50000 Daltons. These materials have been found to beneficial as even in the absence of no pores or orifices, the nylon is quite hydrophilic, thus absorbing to a certain extent water and aqueous solutions. These materials are also suitable to being coated with a detergent formulation which can be released in use, e.g. by melting/vaporisation.

The detergent formulation preferably comprises an aqueous based detergent formulation. The detergent formulation preferably comprises about 90-95 wt % water. The formulation is preferably free of bleach and/or enzymes. The formulation generally comprises one or more of surfactant (anionic, nonionic, and/or cationic), perfume, optical brightener, dye transfer inhibition agent, fragrance, solvent, pH modifier, stability aid, or builder.

The detergent content of the product may be recharged, e.g. by re-applying the detergent formulation to the sheet material and/or particles, e.g. by application from a trigger spray.

According to a second aspect of the invention there is provided the use of a product comprising a pillow made of a plastics sheet material, the material being porous, the product further comprising particles of a support material contained within the pillow, one or more of the particles of support of the plastics sheet material being reversible impregnated with a detergent formulation in a ware washing machine.

It will be understood that features of the first aspect of the invention shall be taken to apply to the second aspect of the invention mutatis mutandis.

Preferably the use comprises a dry cleaning process in a dry cleaning machine.

It is to be understood that in a dry cleaning process clothing/garments and other household items comprising fabric material are to be cleaned. In accordance with the second aspect of invention these items may be inserted inside the pillow to be cleaned or the pillow may be inserted into the dry cleaning machine alongside the items being cleaned (with the items outside the pillow). Most preferably the items to be cleaned are inserted into the pillow. In this case it is foreseen that an additionally/secondary cleaning material may be added to the interior of the pillow together with the items which are to be cleaned.

Where the items are to be inserted in to the pillow the pillow has suitable opening/closing means to allow additional of the items and their retention, plus retention of the particles, throughout the cleaning process.

In use preferably the pillow inflates. This is understood to be caused by heating of any air inside the pillow in combination with, or alternatively as a result of, vaporisation of one of more of the detergent components released from the sheet material or the particulate material. Such inflation may be beneficial in that the pillow may sit in a more stable fashion in the dry cleaning machine. Additionally the evaporation of the detergent formulation has the benefit of being able to moisten fabrics aiding their treatment.

In order to prevent over-inflation of the pillow the sheet material of the pillow may comprise either a valve or a plurality of pores/micropores to allow excess pressure to escape. The valve or a plurality of pores/micropores may also be beneficial in that certain odiferous chemicals (arising from the items being cleaned) are allowed to escape from the pillow and into the dry cleaning machine where they can be removed.

Preferably the use of the pillow is not limited to one single dry cleaning cycle and ideally the pillow is intended to be used over a plurality of separate cycles. Clearly the number of separate cycles will depend upon the amount of degree of soiling of the items being addressed, however, it is intended that the pillow is capable of being used in at least 3 separate wash cycles. Without wishing to be limited by theory it is postulated that the limiting factor on the number of uses of the pillow is related to the level of soiling of the particulate after each cycle and not to the detergent duration, as this will be exhausted after one cycle. However, the detergent content could be recharged, e.g. by re-applying the detergent formulation to the sheet material and/or particles, e.g. by application from a trigger spray.

The invention is further illustrated by reference to the following non-limiting Examples.

### EXAMPLE

The following test was conducted.

Cotton fabric samples were cut with dimensions 10 cm×10 cm (about 2 grams weight). Standard soils were applied (CFT CS-32 (sebum bey/carbon black on cotton), WFK 10K (coffee on cotton), Empa 141 (lipstick on cotton), WFK 10T (ketchup on cotton), Empa 164 (grass on cotton)).

The soiled samples were wetted with water (1:1 sample/water weight ratio) and placed in a Polyethylene/Polypropylene bag having dimensions of 13.5 cm×33 cm and 3.2 litres volume. In the bag were placed also 120 grams of cylindrical Nylon 6, 6 chips having 4 mm length and 2 mm diameter.

Following the same procedure another bag was prepared, using 120 grams of cylindrical Nylon 6, 6 chips having 4 mm length and 2 mm diameter, wherein the chips were coated at 2% by weight with a non ionic surfactant (Lutensol AO 11 from BASF).

Both bags were sealed and placed into domestic tumble dryers (Mod. DDE7709 from General Electric). Both tumble dries were run for a 25 minutes cycle at temperature raising from 40° C. to 70° C. At the end of the treatment the samples were removed from the bags, rinsed for 1 minute under tap water and line dried. Performance was evaluated through change in colour difference using ΔE* and soil removal index SRI %. Results were the following:

### Colour Difference for Stain Removal (ΔE*)

| | CFT CS- | | | | |
|---|---|---|---|---|---|
| | 32 | WFK 10K | Empa 141 | WFK 10T | Empa 164 |
| Chips | 9.93 | 14.92 | 6.29 | 5.39 | 5.07 |
| Coated | 12.66 | 24.61 | 19.54 | 9.95 | 15.78 |
| Chips | | | | | |

### Soil Removal Index (SRI %)

| | CFT CS- | | | | |
|---|---|---|---|---|---|
| | 32 | WFK 10K | Empa 141 | WFK 10T | Empa 164 |
| Chips | 74.46 | 86.93 | 51.36 | 89.74 | 74.74 |
| Coated | 77.14 | 88.50 | 72.44 | 93.10 | 78.10 |
| Chips | | | | | |

1. A product comprising a pillow made of a porous plastics sheet material, further comprising particles of a support material contained within the pillow, one or more of the particles of support of the plastics sheet material being reversibly impregnated with a detergent formulation.

2. A product according to claim 1, wherein the product is in the form of a rectangle having a surface area in the range of 900 cm² to 7000 cm².

3. A product according to claim 1, wherein the weight of the sheet material is in the range of 50 and 200 g/m².

4. A product according to claim 1, wherein the sheet material is a single plastic film or is a combination of two or more films laminated together.

5. A product according to claim 4, wherein the film is formed of or comprises one or more materials selected from polyethylene, polypropylene, polyester, polyamide, poly ethyl vinyl alcohol, optionally comprising a non-woven material.

6. A product according to claim 1, wherein the product comprises particles of support material measured in terms relative to the proposed end use of the product in a weight ratio of between support material:amount of material being addressed of 1:1 and 1:25.

7. A product according to claim 1, wherein the support material is in the form of small cylinders, having dimensions of about 4 mm long and about 2 mm in diameter.

8. A product according to claim 1, wherein the support material comprises a nylon polymer.

9. A product according to claim 1, wherein the detergent formulation comprises an aqueous based detergent formulation.

10. A method of cleaning wares, the method comprising the steps of:
contacting one or more wares with a product comprising a pillow made of a porous plastics sheet material, the product further comprising particles of a support material contained within the pillow, one or more of the particles of support of the plastics sheet material being reversibly impregnated with a detergent formulation in a ware washing machine.

11. The method according to claim 10, wherein the method is used in cleaning one or more garments in a dry cleaning machine.

12. The method according to claim 10, wherein the wares to be cleaned are inserted inside the pillow.

13. The method according to claim 10, wherein the detergent formulation is rechargeable.
